(19) United States
(12) Patent Application Publication
(10) Pub. No.: US 2025/0384166 A1
(43) Pub. Date: Dec. 18, 2025

(54) FORMAL VERIFICATION METHOD AND SYSTEM FOR INTERLOCKING DATA SECURITY

(71) Applicant: CASCO SIGNAL LTD., Shanghai (CN)

(72) Inventors: Yanqin WANG, Shanghai (CN); Min WEI, Shanghai (CN); Mingyao ZHANG, Shanghai (CN); Yingchun ZHU, Shanghai (CN); Weijuan LI, Shanghai (CN); Cheng ZHANG, Shanghai (CN); Lijuan LIU, Shanghai (CN); Hong CHEN, Shanghai (CN)

(73) Assignee: CASCO SIGNAL LTD., Shanghai (CN)

(21) Appl. No.: 18/878,745

(22) PCT Filed: Nov. 11, 2022
(86) PCT No.: PCT/CN2022/131326

§ 371 Date: Dec. 24, 2024

(30) Foreign Application Priority Data
Sep. 19, 2022 (CN) 202211139197.8

(51) Int. Cl. G06F 21/64; H04L 9/40

(52) U.S. Cl. CPC G06F 21/64; H04L 63/12

(57) ABSTRACT

A formal verification method and system for interlocking data security are provided. The method includes: building an interlocking data formal verification general model by using a formal modeling language; establishing a mapping relation between a set security logical attribute in the interlocking data formal verification general model and an interlocking device, an interlocking logical parameter, and a station interlocking function in interlocking data; performing security conversion on interlocking data to be verified according to the mapping relation to obtain general verification data required by the interlocking data formal verification data general model; and selecting a verification object from the general verification data, and selecting a verification algorithm to automatically verify the verification object by using a formal verification tool to complete formal verification for interlocking data security. The satisfiability and security of special interlocking data for implementing requirements of an interlocking system can be effectively verified.

### CROSS REFERENCE TO THE RELATED APPLICATIONS

This application is the national phase entry of International Application No. PCT/CN2022/131326, filed on Nov. 11, 2022, which is based upon and claims priority to Chinese Patent Application No. 202211139197.8, filed on Sep. 19, 2022, the entire contents of which are incorporated herein by reference.

### TECHNICAL FIELD

The present invention relates to the technical field of track interlocking data verification, in particular to a formal verification method and system for interlocking data security.

### BACKGROUND

A computer interlocking system is a high-security system that involves the safety of lives and properties in rail transportation, and the security thereof needs to be ensured by the consistency of system logical design and security requirements and special safety protection measures. However, there is a problem that inaccurate system implementation is caused due to inaccurate requirement description, which further causes a final failure of system functions, thereby easily compromising driving safety.

In combination with the design process and characteristics of application data of an interlocking system, manual intervention mainly exists in a design phase of TLE files and VTL files in the interlocking data design process, so the application data of the interlocking system may also have a data security problem in manual design.

Conventional development, design and testing methods for interlocking data cannot prove that a security-related system implemented thereby fully satisfies functional requirements and security requirements. Conventional development, testing and verification methods mainly have the following problems:
1. Requirements are described by using a natural language, the less detailed content of the requirements causes ambiguity easily, and design errors or test errors may occur in both a design phase and a test phase due to a deviation in understanding of the requirement.
2. Conventional testing methods cannot cover all state spaces of a system in a certain testing scenario, which results in that some potential hazards may not be found during testing, but may occur during actual operation.
3. At present, the verification of the security requirements is mainly performed by tracing a corresponding relationship in the development requirement, design and implementation process. Mostly, they stay only at the level of a document and cannot identify all harmful scenarios, therefore, it cannot be ensured that software implementation can avoid all risks to fully meet the security requirements and to verify the security requirements by manual analysis, the efficiency is low, and a lot of human resources need to be invested.

In addition, the complexity of general data design largely depends on the complexity of the station type, and meanwhile, an interlocking data instantiation tool also depends on the station type in functional implementation. For a simple station type, a general interlocking rule can meet a station type requirement; however, for a complex station type, the general interlocking rule cannot meet a functional requirement of the station type, and a logical design of a special interlocking function needs to be performed manually. Meanwhile, due to the complexity of the station types, a double-link instantiation tool for interlocking data cannot adapt to all the station types, and a special station type may cause an error in an interlocking data file generated by instantiation.

### SUMMARY

The present invention is intended to solve at least one of the technical problems in the related art to some extent. To this end, one object of the present invention is to provide a formal verification method for interlocking data security based on Boolean logical characteristics of interlocking data and based on rigorous mathematical proof theory and full-state space exhaustive search. The method has the characteristics of fast execution and high automation, and can effectively verify the satisfiability and security of the realization of requirements of an interlocking system for specific interlocking data.

To achieve the above goal, the present invention is implemented by the technical solution below:

A formal verification method for interlocking data security comprises:
building an interlocking data formal verification general model by using a formal modeling language;
establishing a mapping relation between a set security logical attribute in the interlocking data formal verification general model and an interlocking device, an interlocking logical parameter and a station interlocking function in interlocking data;
performing security conversion on interlocking data to be verified according to the mapping relation to obtain general verification data required by the interlocking data formal verification general model; and
selecting a verification object from the general verification data, and selecting a verification algorithm to automatically verify the verification object by using a formal verification tool, so as to complete formal verification for interlocking data security.

Optionally, a general security requirement of an interlocking system is described by the interlocking data formal verification general model.

Optionally, the security conversion is performed on the interlocking data to be verified by using a double-link interlocking data security conversion tool.

Optionally, the interlocking data comprises at least one of a VTL file that describes interlocking operation logics, a TLE file that describes a station-yard topological structure and signal device attributes, a SyID interface file that describes an interlocking system and other systems and a station-yard device function list STA configuration file.

Optionally, after obtaining the general verification data and before performing automatic verification, the method further comprises: determining a scope of formal verification for the interlocking data according to the station-yard device function list STA configuration file.

Optionally, when verification errors occur to the formal verification tool, a verification error issue list is output via a man-machine interface.

Optionally, the method further comprises:
acquiring and analyzing the verification error issue list to analyze whether there is a counterexample description in the verification error issue list, and performing counterexample verification and debugging according to the counterexample description when there is the counterexample description in the verification error issue list; and
acquiring a counterexample verification analysis result, correcting the interlocking data to be verified according to the counterexample verification analysis result, and returning to the step of performing security conversion on the interlocking data to be verified until all verification objects pass the formal verification.

Optionally, after the verification objects pass the formal verification, the method further comprises: generating an interlocking data security verification report.

Optionally, the method further comprises: comparing double-link files output by the double-link interlocking data security conversion tool, and randomly selecting one link output file from the double-link files as input data of the formal verification tool when the compared double-link files are consistent.

Optionally, the VTL file comprises at least one of state information of devices in a station, internal logical information of interlocked operations, outbound control command information of interlocked operations, and Boolean equation information that describes interlocked logical operation relations between device variables.

Optionally, the TLE file comprises at least one of information on names and device attributes of all signal devices in the station, information on front and back connection relations between devices, and information on route tables that describe interlocking restrictive relations between the signal devices.

Optionally, the SyID interface file comprises at least one of information on operation requests and device state display that interfaces with an upper computer, information on device control commands and state detection that interfaces with a trackside device, information on route states that interfaces with a train control device, and information on drive acquisition that interfaces with an all-electronic execution unit.

Optionally, the station-yard device function list STA configuration file comprises at least one of information on interlocked station devices, route information, signal display information, information on approach sections and information on route release delay time.

To achieve the above goal, a second aspect of the present invention provides a formal verification system for interlocking data security, comprising:
a general verification model building module which is configured to build an interlocking data formal verification general model and establish a mapping relation between a set security logical attribute in the interlocking data formal verification general model and an interlocking device, an interlocking logical parameter and a station interlocking function in interlocking data;
an interlocking data security conversion module connected to the general verification model building module, wherein the interlocking data security conversion module is configured to perform security conversion on interlocking data to be verified according to the mapping relation to obtain general verification data required by the interlocking data formal verification general model;
a formal security verification module connected to the interlocking data security conversion module, wherein the formal security verification module is configured to perform automatic verification on a verification object selected from the general verification data according to a selected verification algorithm;
a formal counterexample verification and debugging module connected to the formal security verification module, wherein the formal counterexample verification and debugging module is configured to acquire and analyze a verification error issue list and perform counterexample verification and debugging on a counterexample description when there is the counterexample description in the verification error issue list; and
an interlocking data security verification result generation module connected to the formal security verification module, wherein the interlocking data security verification result generation module is configured to generate an interlocking data security verification report according to an output result of the formal security verification module.

To achieve the above goal, a third aspect of the present invention provides a computer-readable storage medium, storing a computer program, and when executed by a processor, the computer program implements the formal verification method for interlocking data security described above.

To achieve the above goal, a fourth aspect of the present invention provides an electronic device, comprising a processor and a memory, wherein the memory stores a computer program, and when executed by the processor, the computer program implements the formal verification method for interlocking data security described above.

The present invention at least has the following technical effects:
1. The present invention applies a formal verification technique to the verification of interlocking data of a computer interlocking system to verify the satisfiability of the interlocking system for security specifications after the data configuration is instantiated and to discover errors in the interlocking system due to an incomplete general application model, incomplete application-specific conversion rules and subjectivity of the data verification process in advance, and the instantiated application-specific interlocking data is the actual interlocking software applied on site in an interlocked station, so that the present invention verifies the security of the interlocking data by the formal verification method, thereby further improving the security of interlocked products.
2. The present invention can cover all state spaces of the system in a certain test scenario by the formal verification method combining induction verification and model verification and can verify the situation that a dangerous event cannot occur.
3. In the present invention, the interlocking data formal verification general model is built by using the formal modeling language, which can prevent the occurrence of design errors or test errors caused by deviations from the understanding of requirements.
4. In the present invention, the mapping relation between the set security logical attribute in the interlocking data formal verification general model and the interlocking device, the interlocking logical parameter and the station interlocking function in the interlocking data is established, security conversion is performed on the interlocking data to be verified according to the mapping relation to obtain the general verification data required by the interlocking data formal verification general model, so that this method is suitable for complex station types.
5. The present invention further provides a complete process of performing data proofing by the formal verification tool, and the present invention can also generate the independent interlocking data verification report, so as to provide effective security arguments for system security and facilitate project security evaluation.
6. The present invention further provides configurations of the verification scope of the interlocking data for security requirement attributes; and in the present invention, general security requirements to be verified are selected according to the configurations, and customized verifications are provided for different station interlocking functions and interlocking data, which can reduce the traversal of a non-current-station interlocking function security requirement model in the verification process, thereby effectively improving the software verification efficiency, and more flexibly performing verification on projects of different scales.
7. The present invention further provides an interlocking data security conversion technology for generating verification files in a general format, thereby providing a unified file processing format for the interlocking data in different formats to facilitate the flexible application of the verification model in different interlocking systems.

### BRIEF DESCRIPTION OF THE DRAWINGS

FIG. 1 is a flow chart of a formal verification method for interlocking data security according to an embodiment of the present invention.

FIG. 2 is a structural schematic diagram of interlocking data according to an embodiment of the present invention.

FIG. 3 is a workflow diagram of a formal verification method for interlocking data security according to an embodiment of the present invention.

FIG. 4 is a structural schematic diagram of a formal verification tool according to an embodiment of the present invention.

FIG. 5 is a structural block diagram of a formal verification system for interlocking data security according to an embodiment of the present invention.

### DETAILED DESCRIPTION OF THE EMBODIMENTS

Further description of the present invention in detail will be made below in combination with accompanying drawings and specific embodiments. The advantages and features of the present invention are clearer according to the description and claims below. It is to be noted that the accompanying drawings in a quite simplified form with an inaccurate ratio are merely used to assist in describing the objectives of the embodiments of the present invention conveniently and clearly.

A formal verification method and system for interlocking data security will be described below with reference to the accompanying drawings.

FIG. 1 is a flow chart of a formal verification method for interlocking data security according to an embodiment of the present invention. As shown in FIG. 1, the method includes:
Step S1, building an interlocking data formal verification general model by using a formal modeling language.

In this embodiment, interlocking data are designed based on the control principle of a 6502 relay centralized interlocking relay circuit, which describes the interlocking logical relation in a 6502 electric centralized circuit in a Boolean algebra expression by defining specific syntactic and semantic rules. In terms of description, the interlocking data inherits functional relays defined in the 6502 circuit (in the interlocking data, all the relays are referred to as parameters or variables), mapping associations between interlocking logical parameters and station-yard devices are realized, logical operations are performed on designated parameters of the devices in conjunction with logical operators “AND”, “OR” and “NOT”, and according to link relations between interlocking devices in a station-yard topological structure, the Boolean algebra expression of relays in each logical circuit is abstracted to form a Boolean expression with the interlocking meaning, thereby constituting the specific station interlocking data. It should be noted that the logic of each Boolean equation in the interlocking data is designed according to different application scenarios and different interlocking functions, which defines restrictive relations between signal devices.

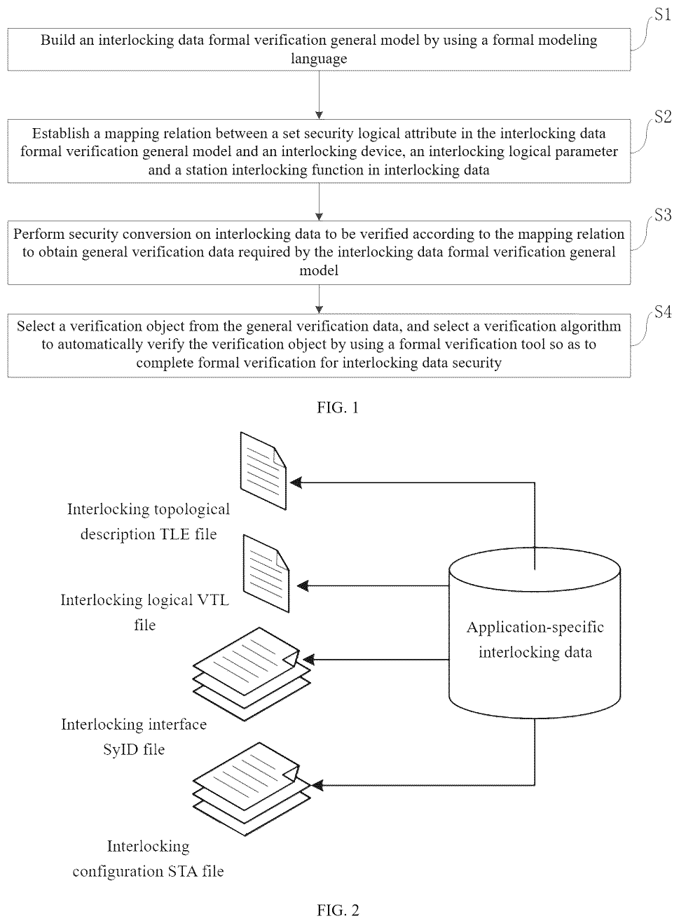

As shown in FIG. 2, the interlocking data in this embodiment includes at least one of a VTL file that describes interlocking operation logics, a TLE file that describes a station-yard topological structure and signal device attributes, a SyID interface file that describes an interlocking system and other systems and a station-yard device function list STA configuration file.

The VTL file is used for recording interlocked logical operation relations between interlocking devices in a station, including at least one of state information of devices in the station, internal logical information of interlocked operations, outbound control command information of interlocked operations, and Boolean equation information that describes interlocked logical operation relations between device variables. The TLE file is a text file, including at least one of information on names and device attributes (such as device types, device usage and special check conditions) of all signal devices in the station, information on front and back connection relations (such as an up-line connection relation and a down-line connection relation) between devices, and information on route tables that describe interlocking restrictive relations between the signal devices. The SyID interface file is used for recording information on all communication interfaces in the interlocking system, including at least one of information on operation requests and device state display that interfaces with an upper computer, information on device control commands and state detection that interfaces with a trackside device, information on route states that interfaces with a train control device, and information on drive acquisition that interfaces with an all-electronic execution unit. The station-yard device function list STA configuration file includes at least one of information on interlocked station devices, route information, signal display information, information on approach sections and information on route release delay time.

In this embodiment, for formal verification of the interlocking data, the simplest and most effective method is to directly verify the converted data of the TLE file and the VTL file, and convert and identify a verification auxiliary input file (STA) file required in a verification process according to verification requirements, so as to verify the security of the interlocking data.

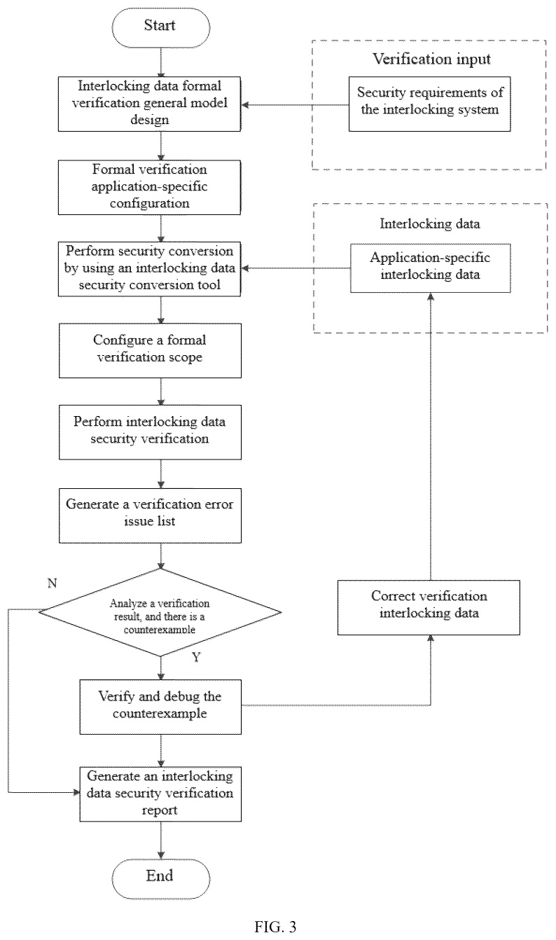

It should be noted that the interlocking data formal verification general model in this embodiment is used for describing general security requirements of the interlocking system. Specifically, as shown in FIG. 3, the general security requirements of the interlocking system described by using the natural language are converted into the interlocking data formal verification general model described by using a formal language to implement formal modeling of the security requirements of the interlocking system.
Step S2, establishing a mapping relation between a set security logical attribute in the interlocking data formal verification general model and an interlocking device, an interlocking logical parameter and a station interlocking function in the interlocking data.

In this embodiment, based on the definition of the security logical attribute in the interlocking data formal verification general model, the mapping relation between the security logical attribute and the interlocking device, the interlocking logical parameter and the station interlocking function in the interlocking data can be established, and verification objects and verification inputs in the interlocking data can be determined.

Specifically, for each single-station interlocking data, naming rules of variables in the interlocking data formal verification general model can be defined for implementing mappings of formal requirement variables and interlocking data code variables. In this embodiment, a citation style of key predicates in matching files on the mappings of formal variables and code variables is CLASSNAME@VARNAME//represents the formal variables of some CLASSNAME (input variables or equations) VARNAME. When missing a variable name occurs, an optional value can be defined as a default value (DEFAULT), and a full name of a corresponding class can be obtained according to the definition of the DEFAULT.

It should be noted that a user also can customize a type in a type module of the system for implementing mappings of complex variable names. Like a TRAIN_ROUTE in the interlocking data, when the route is mapped from a route name to a variable name defining the route name corresponding thereto, a route type suffix of the route name must be ignored.
Step S3, performing security conversion on interlocking data to be verified according to the mapping relation to obtain general verification data required by the interlocking data formal verification general model.

In this embodiment, the security conversion can be performed on the interlocking data to be verified by using a double-link interlocking data security conversion tool. The method further includes: comparing double-link files output by the double-link interlocking data security conversion tool, and randomly selecting one link output file from the double-link files as input data of the formal verification tool when the compared double-link files are consistent.

In this embodiment, the security conversion can be performed on the interlocking data to be verified by using independent dissimilar double-link interlocking data security conversion tools according to data format requirements of the interlocking data formal verification general model to generate the general verification data required by the interlocking data formal verification general model.

Specifically, an application-specific interlocking data file for a certain specific station can be converted into a data format LCF file identifiable by the formal verification tool, where the LCF file format is shown in Table 1 below.

TABLE 1
LCF File Format

| Project table format | Tags | Notes |
|---|---|---|
| Format version | Format: “LCF-1.2- | Define names and |
| number | project-table” | versions of project data |
| | | (indistinguishable in |
| | | size) |
| Name of the project | Package: “ref” | Cite the formats to be |
| package | | instantiated of the |
| | | tables of the data types |
| | | in the package |
| Name of project | Project: “ref” | Define the name of the |
| | | project where the table |
| | | is located |
| Table information | [<table>*]} | Contain 2 member |
| | | variables: type and |
| | | rows |

The conversion can be performed by using double-link interlocking data security conversion tools Translator1&Translator2. In this embodiment, each link translator needs to implement conversion on the VTL file, the TLE file, the STA file and the SyID file and compare double-link output files. When the compared double-link conversion files are consistent, one link output file can be selected randomly as an input of the formal verification tool for verification.

In an embodiment of the present invention, after obtaining the general verification data and before performing automatic verification, the method further includes: determining a scope of formal verification for the interlocking data according to a station-yard device function list STA configuration file.

Specifically, configurable processing can be performed on whether to perform verification on general verification requirements. For example, before verification, the scope of the general verification requirements can be determined according to an interlocked station function list, such as whether there are successive route functions, signal turn-off functions and shunting functions. A requirement defined value that does not need to be verified in a configuration file is always true and is tagged as “AlwaysTrue” and the format thereof is “Verification Requirement Number”: AlwaysTrue. It should be noted that when multiple requirements are not suitable for station data, the station data are configured line by line and one by one.
Step S4, selecting a verification object from the general verification data, and selecting a verification algorithm to automatically verify the verification object with a formal verification tool so as to complete formal verification for interlocking data security.

When verification errors occur to the formal verification tool, a verification error issue list is output via a man-machine interface.

In an embodiment of the present invention, the method further includes: acquiring and analyzing the verification error issue list to analyze whether there is a counterexample description in the verification error issue list, and performing counterexample verification and debugging according to the counterexample description when there is the counterexample description in the verification error issue list; acquiring a counterexample verification analysis result, correcting the interlocking data to be verified according to the counterexample verification analysis result, and returning to the step of performing security conversion on the interlocking data to be verified until all verification objects pass formal verification; and generating an interlocking data security verification report after the verification objects pass the formal verification.

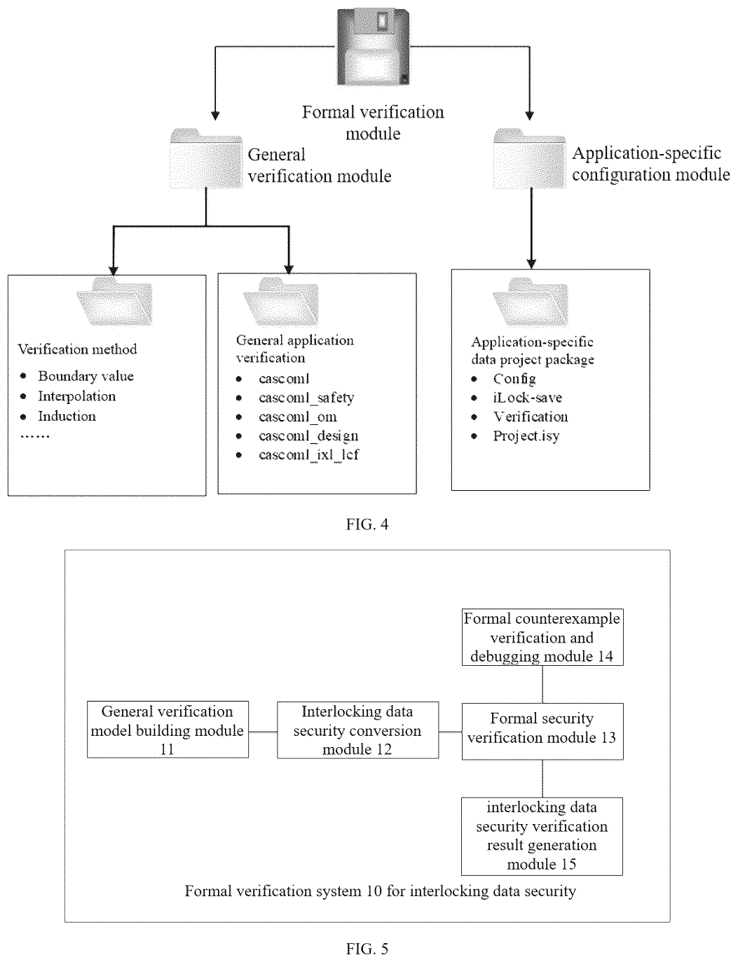

Specifically, the verification algorithm may be selected through the man-machine interface of the formal verification tool, so that the automatic formal verification is performed through the formal verification tool, and a verification result returned by the formal verification tool is waited for. The formal verification tool is shown in FIG. 4, and a formal verification module, namely the formal verification tool, includes a general verification module and an application-specific configuration module, wherein verification methods adopted for the general verification module include boundary value verification, interpolation verification and induction verification.

Further, after completing the verification, the formal verification tool automatically generates a verification record, namely a verification error issue list, of the verification object in the interlocking data associated with each verification requirement in the application-specific data project package/iLock-save, wherein the verification record is used to describe whether the verification object satisfies a security requirement model. The verification object may be a route, a switch, a signal, a section, a section combination, etc.

After outputting the verification error issue list through the man-machine interface, the formal verification tool can analyze whether there is a counterexample description in the verification error issue list, and when it is analyzed that there is the counterexample description, counterexample verification debugging is performed according to the counterexample description so as to search for the reason why the verification object and the requirements do not conform. Specifically, the verification error issue list can be analyzed, for example, the verification object of which a verification result of each security requirement is invalid can be determined, when it is determined that the verification result is invalid, the verification object can be determined as a counterexample of the security requirement, and according to a Boolean equation of the verification object, the actual state of input parameter that makes an operation result of the Boolean equation false is analyzed, and an expected state of the input parameter required by an interlocking application scenario corresponding to a current requirement model is determined. The cause of a data design error corresponding to the inconsistency between the actual state and the expected state of the input parameter is analyzed.

Further, the interlocking data to be verified are corrected according to an error cause analysis result. After the interlocking data to be verified are corrected, the step of performing security conversion on the interlocking data to be verified and the following steps of verification are performed again until verification results of the verification objects corresponding to all the verification requirements are valid, and after the verification objects pass formal verification, an interlocking data security verification report is generated by selection through the man-machine interface of the formal verification tool.

FIG. 5 is a structural block diagram of a formal verification system for interlocking data security according to an embodiment of the present invention. As shown in FIG. 5, the formal verification system 10 for interlocking data security includes a general verification model building module 11, an interlocking data security conversion module 12, a formal security verification module 13, a formal counterexample verification and debugging module 14 and an interlocking data security verification result generation module 15.

The interlocking data security conversion module 12 is an independent module, which is a security tool developed by dissimilar double links, and other modules are integrated verification tools.

In this embodiment, the general verification model building module 11 is configured to build an interlocking data formal verification general model and establish a mapping relation between a set security logical attribute in the interlocking data formal verification general model and an interlocking device, an interlocking logical parameter and a station interlocking function in interlocking data; the interlocking data security conversion module 12 is connected to the general verification model building module 11, and the interlocking data security conversion module 12 is configured to perform security conversion on interlocking data to be verified according to the mapping relation to obtain general verification data required by the interlocking data formal verification general model; the formal security verification module 13 is connected to the interlocking data security conversion module 12, and the formal security verification module 13 is configured to perform automatic verification on a verification object selected from the general verification data according to a selected verification algorithm; the formal counterexample verification and debugging module 14 is connected to the formal security verification module 13, and the formal counterexample verification and debugging module 14 is configured to acquire and analyze a verification error issue list and perform counterexample verification and debugging on a counterexample description when there is the counterexample description in the verification error issue list; and the interlocking data security verification result generation module 15 is connected to the formal security verification module 13, and the interlocking data security verification result generation module 15 is configured to generate an interlocking data security verification report according to an output result of the formal security verification module 13.

It should be noted that specific implementations of the formal verification system for interlocking data security according to the present embodiment can refer to the implementations of the formal verification method for interlocking data security described above, and in order to avoid redundancy, which will not be repeated here.

Further, the present invention provides a computer-readable storage medium, which stores a computer program, and when executed by a processor, the computer program implements the formal verification method for interlocking data security described above.

Further, the present invention provides an electronic device, including a processor and a memory, wherein the memory stores a computer program, and when executed by the processor, the computer program implements the formal verification method for interlocking data security described above.

Since the interlocking data are mainly composed of Boolean logical equations describing interlocking logics, and interlocking Boolean logical equations are connected by first-order predicate logic operators to perform formal verification on the interlocking Boolean logical data, and the formal verification method is used for model verification from the perspective of state spaces. For a perfect interlocking system, in addition to the fact that each functional requirement is correctly realized by testing, it must be verified that the described various hazardous events cannot occur. The present invention adopts a formal verification method combining induction verification and model verification, which can prove that an output of a system cannot cause a hazardous event to occur. All state spaces per cycle can be covered by the model verification, while all cycles can be covered by induction verification.

In an interlocking data preparation process, in the prior art, interlocking data are mainly tested by experience to verify the security thereof, but it is specifically tested by a traversal method, which cannot cover problems of all the state spaces. In the case of limited security requirements, the traversal testing a small and medium-sized station needs to consume up to 2 months, while the present invention uses the formal verification method for interlocking data to complete the security verification of the interlocking data in about 1 day, which greatly improves the scope and efficiency of interlocking data verification, and reduces human costs, thereby improving the security of system software based on a solid theory foundation with an advanced technical method, and further ensuring the driving safety.

In addition, the present invention has been applied to the security verification of the interlocking data of an iLOCK interlocking system and also applied to actual station data. The present invention uses a formal method for verifying the interlocking data, thereby providing a guarantee for the security of the system. Since the internal security of an interlocking system mainly involves the Boolean logic in the interlocking data, and interlocking formal verification adopted in the present invention starts from the security requirements of the system; model verification proves that the security requirements of interlocking software have been achieved and system functions satisfy system requirements; in addition, in the present invention, defects in the design of the interlocking system can be discovered by verification as early as possible, thereby improving product quality and security.

In conclusion, the present invention can cover all the state spaces of the system in a certain testing scenario by the formal verification method combining induction verification and model verification and can verify the situation that a dangerous event cannot occur; in the present invention, the interlocking data formal verification general model is built by using the formal modeling language, which can prevent the occurrence of design errors or test errors caused by deviations from the understanding of the requirements; in the present invention, the mapping relation between the set security logical attribute in the interlocking data formal verification general model and the interlocking device, the interlocking logical parameter and the station interlocking function in the interlocking data is established, security conversion is performed on the interlocking data to be verified according to the mapping relation to obtain the general verification data required by the interlocking data formal verification general model, so that this method is suitable for complex station types; the present invention further provides a complete process of performing data proofing by the formal verification tool, and the present invention can also generate the independent interlocking data verification report, so as to provide effective security arguments for the system security and facilitate project security evaluation; the present invention further provides configurations of the verification scope of the interlocking data for security requirement attributes; and in the present invention, general security requirements to be verified are selected according to the configurations, and customized verifications are provided for different station interlocking functions and interlocking data, which can reduce the traversal of a non-current-station interlocking function security requirement model in the verification process, thereby effectively improving the software verification efficiency, and more flexibly performing verification on projects of different scales; and finally, the present invention further provides an interlocking data security conversion technology for generating verification files in a general format, thereby providing a unified file processing format for the interlocking data in different formats to facilitate flexible application of the verification model in different interlocking systems.

While the contents of the present invention have been described in detail by the foregoing preferred embodiments, it should be understood that the aforementioned descriptions shall not be construed as limiting the present invention. Various modifications and alternatives to the present invention will become apparent to those skilled in the art upon reading the foregoing disclosure. Accordingly, the protection scope of the present invention shall be limited by the appended claims.

What is claimed is:

1. A formal verification method for an interlocking data security, comprising:
building an interlocking data formal verification general model by using a formal modeling language;
establishing a mapping relation between a set security logical attribute in the interlocking data formal verification general model and an interlocking device, an interlocking logical parameter, and a station interlocking function in interlocking data;
performing a security conversion on interlocking data to be verified according to the mapping relation to obtain general verification data required by the interlocking data formal verification general model; and
selecting a verification object from the general verification data, and selecting a verification algorithm to automatically verify the verification object by using a formal verification tool, to complete formal verification for the interlocking data security.

2. The formal verification method for the interlocking data security according to claim 1, wherein a general security requirement of an interlocking system is described by the interlocking data formal verification general model.

3. The formal verification method for the interlocking data security according to claim 1, wherein the security conversion is performed on the interlocking data to be verified by using a double-link interlocking data security conversion tool.

4. The formal verification method for the interlocking data security according to claim 3, wherein the interlocking data comprises at least one of a VTL file, a TLE file, a SyID interface file, and a station-yard device function list STA configuration file, wherein the VTL file describes interlocking operation logics, the TLE file describes a station-yard topological structure and signal device attributes, the SyID interface file describes an interlocking system and other systems.

5. The formal verification method for the interlocking data security according to claim 4, wherein after obtaining the general verification data and before performing automatic verification, the formal verification method further comprises: determining a scope of the formal verification for the interlocking data security according to the station-yard device function list STA configuration file.

6. The formal verification method for the interlocking data security according to claim 1, wherein when verification errors occur to the formal verification tool, a verification error issue list is output via a man-machine interface.

7. The formal verification method for the interlocking data security according to claim 6, further comprising:
acquiring and analyzing the verification error issue list to analyze whether a counterexample description exists in the verification error issue list, and performing counterexample verification and debugging according to the counterexample description when the counterexample description exists in the verification error issue list; and
acquiring a counterexample verification analysis result, correcting the interlocking data to be verified according to the counterexample verification analysis result, and returning to the step of performing the security conversion on the interlocking data to be verified until all verification objects pass the formal verification.

8. The formal verification method for the interlocking data security according to claim 7, wherein after the verification objects pass the formal verification, the formal verification method further comprises: generating an interlocking data security verification report.

9. The formal verification method for the interlocking data security according to claim 3, further comprising: comparing double-link files output by the double-link interlocking data security conversion tool, and randomly selecting one link output file from the double-link files as input data of the formal verification tool when the double-link files are consistent.

10. The formal verification method for the interlocking data security according to claim 4, wherein the VTL file comprises at least one of state information of devices in a station, internal logical information of interlocked operations, outbound control command information of the interlocked operations, and Boolean equation information, wherein the Boolean equation information describes interlocked logical operation relations between device variables.

11. The formal verification method for the interlocking data security according to claim 4, wherein the TLE file comprises at least one of information on names and device attributes of all signal devices in a station, information on front and back connection relations between the signal devices, and information on route tables, wherein the information on route tables describe interlocking restrictive relations between the signal devices.

12. The formal verification method for the interlocking data security according to claim 4, wherein the SyID interface file comprises at least one of information on operation requests and device state display, information on device control commands and state detection, information on route states, and information on drive acquisition, wherein the information on operation requests and device state display interfaces with an upper computer, the information on device control commands and state detection interfaces with a trackside device, the information on route states interfaces with a train control device, and the information on drive acquisition interfaces with an all-electronic execution unit.

13. The formal verification method for the interlocking data security according to claim 4, wherein the station-yard device function list STA configuration file comprises at least one of information on interlocked station devices, route information, signal display information, information on approach sections, and information on route release delay time.

14. A formal verification system for an interlocking data security, comprising:
a general verification model building module, wherein the general verification model building module is configured to build an interlocking data formal verification general model and establish a mapping relation between a set security logical attribute in the interlocking data formal verification general model and an interlocking device, an interlocking logical parameter, and a station interlocking function in interlocking data;
an interlocking data security conversion module connected to the general verification model building module, wherein the interlocking data security conversion module is configured to perform a security conversion on interlocking data to be verified according to the mapping relation to obtain general verification data required by the interlocking data formal verification general model;
a formal security verification module connected to the interlocking data security conversion module, wherein the formal security verification module is configured to perform automatic verification on a verification object selected from the general verification data according to a selected verification algorithm;
a formal counterexample verification and debugging module connected to the formal security verification module, wherein the formal counterexample verification and debugging module is configured to acquire and analyze a verification error issue list and perform counterexample verification and debugging on a counterexample description when the counterexample description exists in the verification error issue list; and
an interlocking data security verification result generation module connected to the formal security verification module, wherein the interlocking data security verification result generation module is configured to generate an interlocking data security verification report according to an output result of the formal security verification module.

15. A computer-readable storage medium, storing a computer program, wherein when executed by a processor, the computer program implements the formal verification method for the interlocking data security according to claim 1.

16. An electronic device, comprising a processor and a memory, wherein the memory stores a computer program, and when executed by the processor, the computer program implements the formal verification method for the interlocking data security according to claim 1.
